(19) United States
(12) Patent Application Publication
(10) Pub. No.: US 2006/0167684 A1
(43) Pub. Date: Jul. 27, 2006

(54) Speech recognition method and system

(75) Inventors: Ching-Ho Tsai, Huatan Township (TW); Jui-Chang Wang, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/112,212

(22) Filed: Apr. 22, 2005

(30) Foreign Application Priority Data
Jan. 24, 2005 (TW) 094102062

(51) Int. Cl. G10L 15/00

(52) U.S. Cl. 704/231

(57) ABSTRACT

In the present invention, a speech recognition method is provided. The speech recognition method includes steps of (a) receiving a speech from a user and recognizing the speech for generating a plurality of recognition results, (b) displaying the recognition results for the user to lock correct values in the recognition results, (c) determining whether the correct values are sufficient for searching a database, (d) saving the correct values as known values to narrow the recognition range and repeating step (a) to step (c) when the correct values are insufficient for searching the database, and (e) searching the database for a desired datum based on the correct values when the correct values are sufficient.

### FIELD OF THE INVENTION

The present invention relates to a speech recognition method and system, and more particularly to a speech recognition method and system in which the recognition results could be confirmed or corrected.

### BACKGROUND OF THE INVENTION

The results of the speech recognition often contain a number of errors. Currently, there are two ways to deal with the errors. One is to re-input the whole speech by the user for correction. The other is to correct the errors with the correcting dialog method specified by the speech recognition system, which requires the user to input the speech one by one for speech recognition and confirmation. Both of the ways are undesirable because the user has to spend lots of time on the confirmation and correction processes.

Please refer to FIG. 1, which shows the flow chart of the speech recognition method in the prior art. At first, the clues are raised by the system (step 11). Then, the corresponding speech is inputted by the user to the system (step 12). Next, the speech from the user is recognized by the system (step 13). The recognition results will serve as known values and be stored in the storage device 15, such as a register, if the recognition results are correct (step 14). Finally, the system determines whether the known values are sufficient for searching the database (step 16). Whereas the procedure proceeds back to step 11 to re-raise the clues for the user when the known values are not sufficient.

Generally, the conventional speech recognition method as depicted in FIG. 1 is implemented either with or without display interface.

Without display interface, the clues are raised by the system via producing speech for the user. In this way, not only some errors might be caused due to the mis-hearing by the user, but a lot of time is required for the system to raise the clues via speech. If parts of the results are erroneously judged during the speech recognition in the case that more than one value of speech is allowed to be inputted into the system at the same time, the correction can be made either through re-inputting the whole speech by the user or through the correcting dialog method specified by the speech recognition system. Both of the two ways are time-consuming. Besides, the recognition results of the re-inputted speech are not guaranteed to be completely correct.

With display interface, the delay and inaccuracy resulting from the speech interface can be avoided. That is, the recognition results can be shown on the display interface so that the user can judge whether the recognition results are correct or not. However, the correction for the recognition results could only be made by the speech interface. This is completely the same as the speech recognition system without display interface.

Additionally, more and more advanced multimedia data storage/playing devices are available in the market, which are capable of storing lots of data or playing plenty of programs. Therefore, it is more and more difficult to do the search and retrieval for the data or programs.

Presently, the search and retrieval method for data or programs on the portable device is to press the buttons thereon to select the desired function from the menu. This could be achieved by directly pressing the buttons on the portable device or by employing the buttons on the remote controller, e.g. the function control button or the channel selection button for the recorder or television. Owing to the limitation for the number of buttons on the portable device, the display interface with a hierarchical menu is often used for assistance. Such a complicated hierarchical menu not only becomes a nuisance for the user but is inefficient.

There are also more and more intelligent portable devices available in the market. Take the personal digital assistant (PDA) for example, it could record a lot of data, such as telephones and addresses, personal calendars, personal notebooks, MP3 files, radio channels and so on. The functions and commands of the portable device are increasing, but the number of buttons thereon is not correspondingly increased due to the limitation for the volume thereof. Moreover, the display of the portable device is too small to show all of the functions and commands thereon, not to mention the difficulty for the user to memorize so many commands. Hence, it is desirable to employ the speech recognition as the input interface for the portable device.

Even though the employment of the speech recognition as the input interface is more natural for the user, there are still many problems to be solved, however. For example, the recognition results usually contain a number of errors, and the method for correcting these errors is inefficient, which bring the user a serious inconvenience while using the portable device. Therefore, it is of great urgency to develop a better and more convenient speech recognition method and system therefor.

In order to overcome the drawbacks in the prior art, a novel speech recognition method and system are provided. The particular design in the present invention not only solves the problems described above, but also is easy to be implemented.

### SUMMARY OF THE INVENTION

In accordance with one aspect of the present invention, a speech recognition method and system for the portable device are provided. In the speech recognition system, a displaying device is used for displaying the recognition results, and a locking device is used for confirming the recognition results.

In accordance with another aspect of the present invention, a speech recognition method and system for the portable device are provided. In the speech recognition system, a specific region of the displaying device serves as the communication interface for language understanding, and a keypad is used for confirming/correcting the recognition results.

In accordance with a further aspect of the present invention, a speech input method and system for the portable device are provided. The portable device is capable of being connected to a remote server via the wireless network to access the database of the remote server. In this way, not only the capacity of the database in the portable device can be economized, but the efficiency thereof can be reinforced.

In accordance with further another aspect of the present invention, a speech recognition method is provided. The speech recognition method includes steps of (a) receiving a speech from a user and recognizing the speech for generating a plurality of recognition results, (b) displaying the recognition results for the user to lock correct values in the recognition results, (c) determining whether the correct values are sufficient for searching a database, (d) saving the correct values as known values to narrow the recognition range and repeating step (a) to step (c) when the correct values are insufficient for searching the database, and (e) searching the database for a desired datum based on the correct values when the correct values are sufficient.

Preferably, the recognition results are shown on a displaying device.

Preferably, the displaying device is a touch screen.

Preferably, the correct values in the recognition results are locked by the user with a locking device.

Preferably, the locking device is one selected from a group consisting of a button, the touch screen and a remote controller.

Preferably, the known values are stored in a storage device.

Preferably, the storage device is a register.

Preferably, the database is one selected from a group consisting of a memory, a flash disk, a hard disk and a remote server.

Preferably, the speech recognition method further includes a step of re-recognizing the speech from the user when a part of the correct values is known.

In accordance with further another aspect of the present invention, a speech recognition method is provided. The speech recognition method includes steps of (a) displaying a plurality of fields on a displaying device, wherein each of the field corresponds to an attribute, (b) inputting a speech by a user based on the attribute, (c) recognizing the speech to generate a plurality of recognition results, (d) displaying the recognition results in corresponding fields for the user to lock correct values in the recognition results with a locking device, (e) determining whether the correct values are sufficient for searching a database, (f) saving the correct values as know values to narrow the recognition range and repeating step (b) to step (e) when the correct values are insufficient for searching the database, and (g) searching the database for a desired datum based on the correct values when the correct values are sufficient.

Preferably, the speech recognition method further includes a step of re-recognizing the speech from the user when a part of the correct values is known.

Preferably, the speech recognition method further includes a step of automatically searching for the desired datum without completely filling the fields.

In accordance with further another aspect of the present invention, a speech recognition system is provided. The speech recognition system includes a speech input device for receiving a speech from a user, a speech recognition device connected to the speech input device for recognizing the speech to generate a plurality of recognition results, a displaying device connected to the speech recognition device for displaying the recognition results, a locking device connected to the displaying device for the user to lock correct values in the recognition results, a storage device for saving the correct values as known values, and a database for storing a desired datum to be searched according to the correct values.

Preferably, the displaying device is a touch screen.

Preferably, the locking device is one selected from a group consisting of a button, the touch screen and a remote controller.

Preferably, the storage device is a register.

Preferably, the correct values are saved as the known values via the storage device when the correct values are insufficient.

Preferably, the database is one selected from a group consisting of a memory, a flash disk, a hard disk and a remote server.

Preferably, the desired datum is searched from the database based on the correct values when the correct values are sufficient for searching the database.

In accordance with further another aspect of the present invention, a speech recognition method is provided. The speech recognition method includes steps of (a) receiving a speech from a user and recognizing the speech for generating a plurality of recognition results, (b) displaying one pair of the recognition results for the user to confirm/correct the recognition result, (c) repeating step (b) until all of the recognition results are confirmed/corrected by the user, and (d) searching for a desired datum based on the confirmed/corrected recognition results.

Preferably, the recognition results are shown one by one on a specific region of a displaying device.

Preferably, the recognition results are shown as an ‘attribute-value’ format.

Preferably, the attributes and said values are confirmed/corrected one by one by the user via a control device.

Preferably, the control device is one selected from a group consisting of a keypad, a remote controller and a personal digital assistant.

Preferably, the keypad includes a recording/playing button, an accepting button, a rejecting button, an attribute-correcting button and a value-correcting button.

Preferably, the speech recognition method further includes a step of searching for the desired datum based on the confirmed/corrected attributes and the confirmed/corrected values after one of the attributes and the values is confirmed/corrected.

Preferably, the speech recognition method further includes a step of determining whether the attributes and the values which are not confirmed/corrected need to be confirmed/corrected continuously.

In accordance with further another aspect of the present invention, a speech recognition system is provided. The speech recognition system includes an input device for receiving a speech from a user, a speech recognition understanding device connected to the input device for generating a plurality of recognition results in response to the speech, a confirmation/correction module connected to the speech recognition understanding device for confirming/correcting the recognition results, a displaying device connected to the confirmation/correction module for displaying the recognition results one by one on a specific region thereof, a control device connected to the confirmation/correction module for the user to confirm/correct the recognition results, and a search module connected to the confirmation/correction module for searching for a desired datum based on the confirmed/corrected recognition results.

Preferably, the speech recognition system further includes a storage/receiving device for storing the datum.

Preferably, the datum is one of a digital datum and a video program.

Preferably, the input device is a microphone.

Preferably, the speech recognition understanding device includes a speech recognition device and a language understanding device.

Preferably, the speech recognition device performs a speech recognition based on a lexicon.

Preferably, the language understanding device performs a language understanding based on a grammar rule.

Preferably, the recognition results are shown as an ‘attribute-value’ format.

Preferably, the confirmation/correction module is an interactive meaning confirmation/correction software.

Preferably, the control device is one selected from a group consisting of a keypad, a remote controller and a personal digital assistant.

Preferably, the keypad includes a recording/playing button, an accepting button, a rejecting button, an attribute-correcting button and a value-correcting button.

Preferably, the search unit is a search software.

In accordance with further another aspect of the present invention, a speech recognition method is provided. The speech recognition method includes steps of (a) receiving a speech from a user and recognizing the speech for generating a plurality of recognition results, (b) displaying the recognition results for the user to confirm/correct the recognition results, and (c) searching for a desired datum based on the confirmed/corrected recognition results.

Preferably, the recognition results are shown simultaneously.

Preferably, the recognition results are shown one by one.

Preferably, the step (b) is performed by receiving a next speech from the user.

Preferably, the step (b) is performed by means of a control device.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the flow chart of the speech recognition method in the prior art;

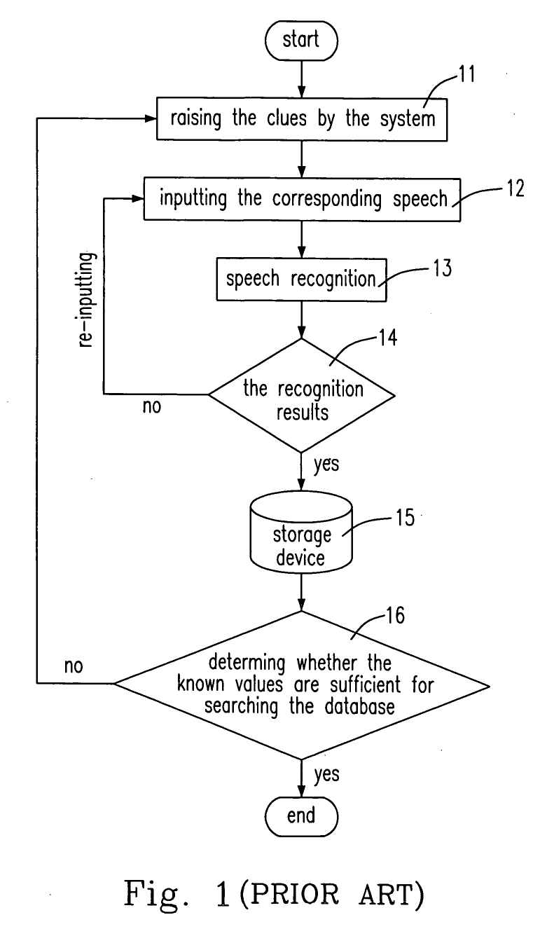

FIG. 2 is a schematic diagram showing the structure of the speech recognition system according to a preferred embodiment of the present invention;

FIG. 3 is the flow chart of the speech recognition method according to a preferred embodiment of the present invention;

FIG. 4 shows the application of the speech recognition system on a portable device according to a preferred embodiment of the present invention;

FIG. 5 is a schematic diagram showing the structure of the speech recognition system according to another preferred embodiment of the present invention;

FIG. 6 shows the arrangement of the buttons on the keypad according to another preferred embodiment of the present invention;

FIG. 7 shows the application of the speech recognition system on an MP3 player according to another preferred embodiment of the present invention; and

FIG. 8 shows the application of the speech recognition system on a television according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

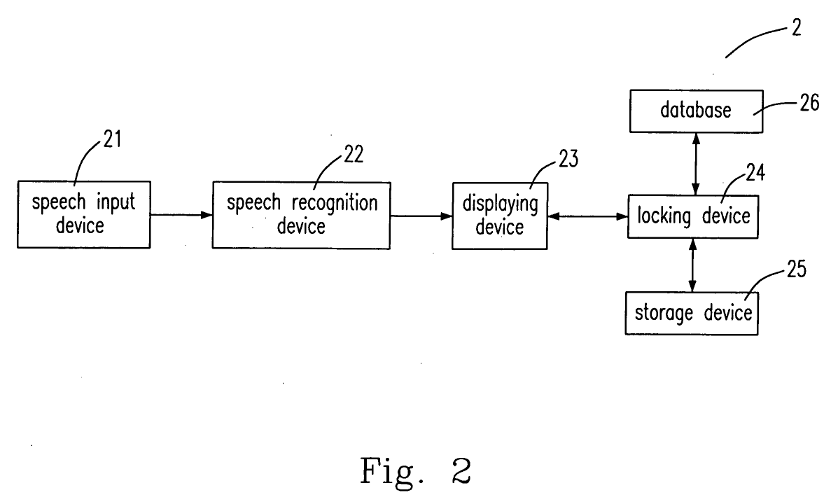

Please refer to FIG. 2, which shows the structure of the speech recognition system according to a preferred embodiment of the present invention. The speech recognition system 2 includes a speech input device 21, a speech recognition device 22, a displaying device 23, a locking device 24, a storage device 25 and a database 26. The speech input device 21 is used for receiving a speech from a user. The speech recognition device 22 is used for recognizing the speech and generating a plurality of recognition results according thereto. The displaying device 23 is used for displaying the recognition results. The locking device 24 is used for the user to lock correct values in the recognition results. The storage device 25 is used for saving the correct values as known values if the correct values are insufficient for searching the database 26. The database 26 is used for storing a desired datum to be searched according to the correct values when the correct values are sufficient for searching the database 26.

Preferably, the locking device 24 is a button, a touch screen or a remote controller. When the locking device 24 is a touch screen, the touch screen may also serve as the displaying device 23. Moreover, the storage device 25 is preferably a register. The database 26 is preferably a memory, a flash disk, a hard disk or a remote server. Any kinds of data can be searched via the speech recognition system 2 described above, such as the flight timetable, the stock information, etc.

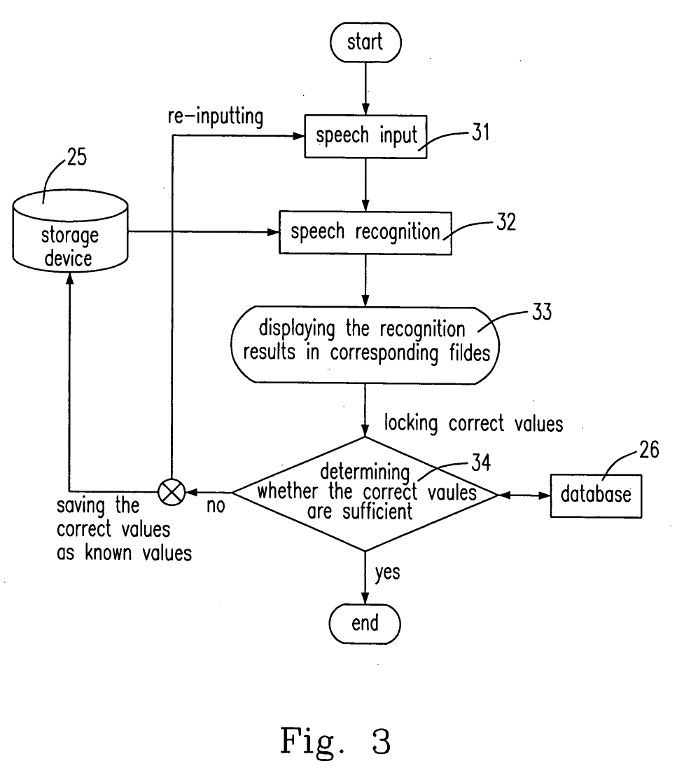

Please refer to FIGS. 2 and 3 simultaneously. FIG. 3 shows the flow chart of the speech recognition method according to a preferred embodiment of the present invention. The user can input a speech after looking through a plurality of fields shown on the displaying device (step 31). Next, the speech recognition is performed (step 32), and the recognition results are displayed in the corresponding fields (step 33) for being selected by the user with the locking device 24 and serving as correct values, so as to be locked. After the correct values are locked, the system determines whether the correct values are sufficient for searching the database 26 (step 34). If the correct values are insufficient for searching the database 26, the locked correct values will be saved as known values via the storage device 25, and the process will go back to step 31 until the correct values are sufficient for searching the database 26. The speech input process will finish if the correct values are sufficient for searching the database 26. Meanwhile, the desired datum is searched from the database 26 according to the correct values.

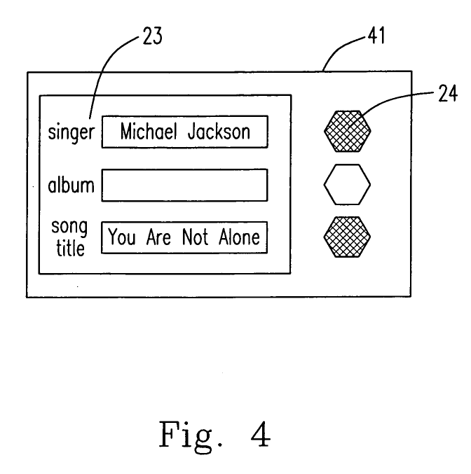

Referring now to FIG. 4, which shows the application of the speech recognition system on a portable device according to a preferred embodiment of the present invention, wherein the portable device is a song-searching device. As shown in FIG. 4, the value for the field of the attribute “singer” is “Michael Jackson”, the value for the field of the attribute “song title” is “You Are Not Alone”, and the field of the attribute “album” is empty. Since the field of the attribute “album” is empty, the value therefor is unknown. Hence, the field needs to be filled by inputting the speech from the user for searching the desired song.

The speech recognition method and system described above have the following advantages.

1. The recognition results are shown on the displaying device 23 in the format of “attribute-value”. Therefore, it is easy for the user to identify which fields are still empty. That is, the user knows which speech he should input next without the questioning from the system.

2. The way of locking known values is adopted to eliminate the occurrence of incorrect speech recognition. After the user inputs his speech, the recognition results will be shown in corresponding fields. The correct values can be selected either by keeping the correct values or by deleting the incorrect values. After that, the correct values kept are locked and regarded as known values that are unchangeable. The next speech from the user can only change the fields that are not locked. Thus, the recognition range can be narrowed down. This not only enhances the rate of recognition but reduces the time required for the speech recognition.

3. The user can input more than one attribute at a time by the way of natural language.

4. The recognition range can be narrowed down when a part of the values for the fields is known.

5. The speech from the user can be re-recognized when a part of the values for the fields is known.

6. The desired datum can be searched automatically by the system without completely filling the fields.

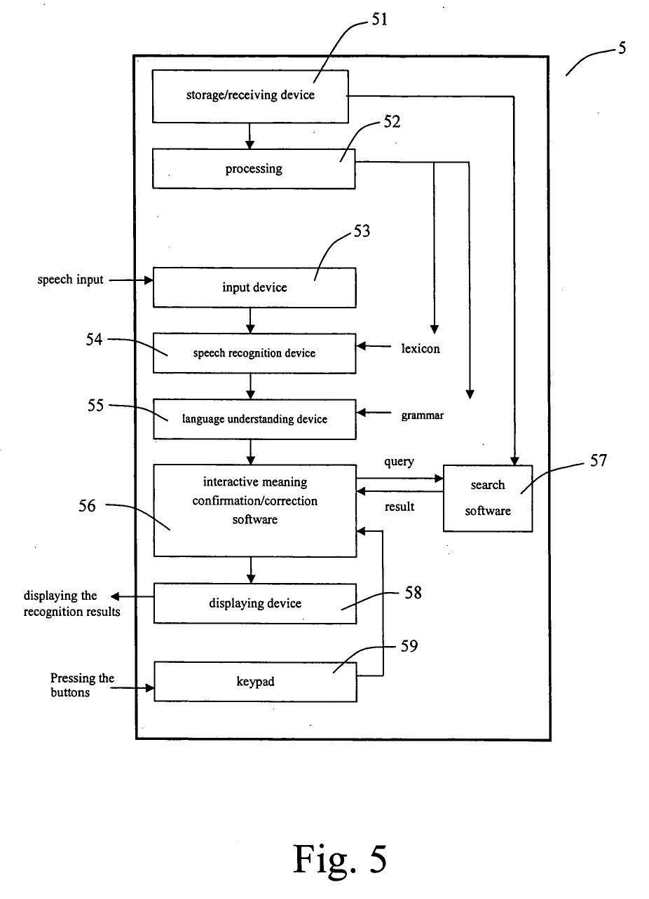

Please refer to FIG. 5, which schematically shows the structure of the speech recognition system according to another preferred embodiment of the present invention. The speech recognition system 5 includes a storage/receiving device 51 for the digital data or the video programs, an interactive speech recognition understanding device and a search software 57. Preferably, the storage/receiving device 51 is an MP3 player, a radio or a television. The interactive speech recognition understanding device includes an input device 53 (such as a microphone), a displaying device 58 (such as a screen), a keypad 59, a speech recognition device 54, a language understanding device 55 and an interactive meaning confirmation/correction software 56.

The input device 53 is used for receiving a speech from a user. The speech recognition device 54 performs speech recognition based on a lexicon. The language understanding device 55 performs language understanding based on a grammar rule to generate a plurality of recognition results. The lexicon and the grammar are generated from processing the digital data or the video programs of the storage/receiving device 51 (step 52). The interactive meaning confirmation/correction software 56 is used for confirming/correcting the recognition results. The displaying device 58 is used for displaying the recognition results one by one on a specific region thereof. The keypad 59 is used for the user to confirm/correct the recognition results. Alternatively, the keypad 59 can be replaced with a remote controller or a personal digital assistant. The search software 57 is used for searching the storage/receiving device 51 based on the confirmed/corrected recognition results so as to find out the corresponding digital data or video programs.

The titles of the digital data or video programs being stored or received in the storage/receiving device should be classified in advance according to their attributes. For instance, “You are not alone” by “Michael Jackson” is classified as the value for the attribute of “song”, and the value for the attribute of “singer” is “Michael Jackson”. The program “CNN Live Today” is a value for the attribute of “program name”, the corresponding value for the attribute of “program category” is “news program”, the corresponding value for the attribute of “radio station” is “CNN”, and the corresponding value for the attribute of “time” is “AM 10-12”.

During the search, the user only needs to use daily sentences. For example, the user speaks “turn to CNN Live Today” or “You are not alone by Michael Jackson” In this way, the unnaturally hierarchical instructions, such as speaking “television”, “news program”, and finally the program name “CNN Live Today” in turn, are unnecessary anymore.

The corresponding lexicon and grammar generated from processing the classified titles of the digital data or video programs will serve as the basis of the speech recognition and the language understanding. Furthermore, the speech recognition device 54 and the language understanding device 55 can be combined into a single component.

After the speech from the user is received by the interactive speech recognition understanding device 55, it is interpreted as the “attribute-value” format in pairs by the speech recognition device 54 and the language understanding device 55, even if the user doesn't speak the attribute. For instance, when the user speaks “You are not alone by Michael Jackson” without speaking “singer”, an “attribute-value” pair “singer-Michael Jackson” will be shown on the displaying device. Many “attribute-value” pairs can be generated from a single sentence spoken by the user. Finally, the erroneous meaning is corrected or the correct meaning is confirmed through the interactive meaning confirmation/correction software 56. The speech recognition method for this preferred embodiment will be illustrated in detail as follows.

1. The speech recognition method for this preferred embodiment is designed for confirming/correcting an “attribute-value” pair at a time. In this way, an “attribute-value” pair is shown on a specific region of the displaying device 58, so that the user could still watch the programs normally. In addition, the interactive confirmation and correction can be made easily by using the keypad 59 which consists of five buttons.

2. Only one “attribute-value” pair is shown on the displaying device 58 at a time. Moreover, the keypad 59 consisting of five buttons is provided for interacting with the speech from the user.

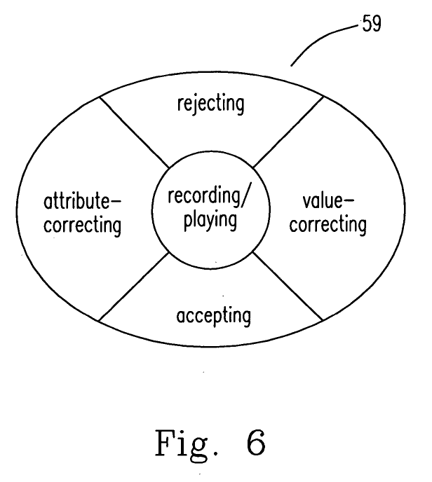

3. Please refer to FIG. 6, which shows the arrangement of the buttons on the keypad 59 according to another preferred embodiment of the present invention. The five buttons are respectively a recording/playing button, an accepting button, a rejecting button, an attribute-correcting button and a value-correcting button.

The recording/playing button: The speech section from the user corresponding to the shown “attribute-value” pair could be played when the recording/playing button is pressed softly. The re-recording function could be performed when the recording/playing button is pressed heavily or lastingly so as to re-confirm/re-correct the “attribute-value” pairs.

The accepting button: The shown “attribute-value” pair are accepted when the accepting button is pressed softly, and then a next action is proceeded. The next action is to show the next “attribute-value” pair that are not confirmed/corrected yet for interaction with the user, if any.

The rejecting button: The shown “attribute-value” pair are rejected when the rejecting button is pressed softly, and then a next action is proceeded. The next action is to show the next “attribute-value” pair that are not confirmed/corrected yet for interaction with the user, if any.

The attribute-correcting button: A new attribute in another Top-N candidate “attribute-value” pair is corrected and selected when the attribute-correcting button is pressed softly. The re-recording function could be performed and then a new attribute in another possible “attribute-value” pair is identified when the attribute-correcting button is pressed heavily or lastingly.

The value-correcting button: A new value in another Top-N candidate “attribute-value” pair is corrected and selected when the attribute-correcting button is pressed softly. The re-recording function could be performed and then a new value in another possible “attribute-value” pair is identified when the value-correcting button is pressed heavily or lastingly.

If there are a plurality of “attribute-value” pairs, the displaying sequence therefor is determined by the system based on an intelligent judgment thereof instead of the sequence of the speech. The consideration for determining the displaying sequence for the “attribute-value” pairs is based on an operation convenience for the user. For instance, the interaction should be highly natural and times for pressing the buttons should be less.

The search could be performed after any of the “attribute-value” pairs is confirmed/corrected. Meanwhile, whether the confirming/correcting process for the unconfirmed/uncorrected “attribute-value” pairs needs to proceed or not is determined automatically by the system. In addition, the search results (the amount or the respective items) could be shown on the displaying device 58 for being consulted.

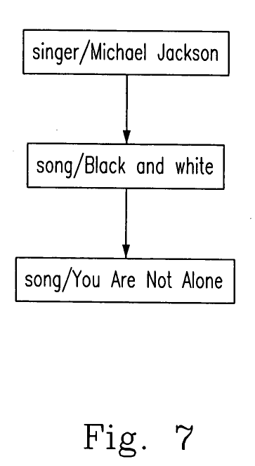

Referring now to FIGS. 6 and 7 simultaneously. FIG. 7 shows the application of the speech recognition system on an MP3 player according to another preferred embodiment of the present invention. At first, the user speaks “Michael Jackson You are not alone”, then the speech recognition is performed. Next, the “attribute-value” pair as “singer/Michael Jackson” is shown on the displaying device 58. After the accepting button is pressed, the “attribute-value” pair as “song/Black and White” is shown on the displaying device 58. At this time, the user presses the value-correcting button to correct the value. Finally, the “attribute-value” pair as “song/You Are Not Alone” is shown on the displaying device 58. After the accepting button is pressed by the user, the song file of “You Are Not Alone” is searched from the storage/receiving device 51 based on the confirmed/corrected recognition results.

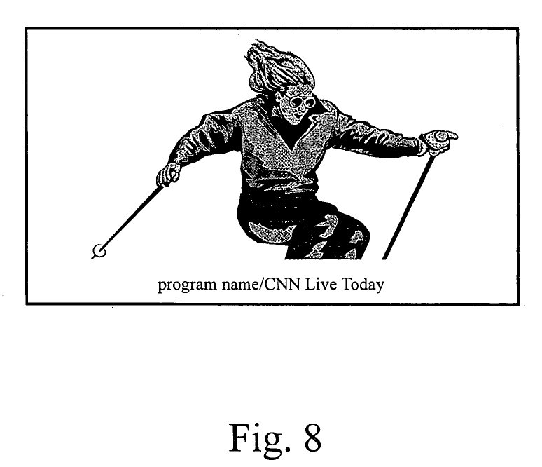

The function of human-machine interface is provided in the interactive speech recognition understanding device of this preferred embodiment, which is able to search mass information rapidly and effectively. This preferred embodiment could be applied to devices with a small-scale screen, for example, a small digital data storage/playing device such as the MP3 player, the smart phone and so on. Also, this preferred embodiment could be applied to the device with a large-scale screen. The characteristic of this preferred embodiment lies in that only a small part of the screen is used as the communication interface for speech understanding, so that the user could still watch the program normally. For example, it could be applied to the control for the television, the program selection, the adjustment for the video quality, etc. Furthermore, it could also be applied to the control for the video recorder, such as setting the recording time, playing the pre-recorded program and so on, as shown in FIG. 8.

Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A speech recognition method, comprising steps of:
(a) receiving a speech from a user and recognizing said speech for generating a plurality of recognition results;
(b) displaying said recognition results for said user to lock correct values in said recognition results;
(c) determining whether said correct values are sufficient for searching a database;
(d) saving said correct values as known values to narrow the recognition range and repeating step (a) to step (c) when said correct values are insufficient for searching said database; and
(e) searching said database for a desired datum based on said correct values when said correct values are sufficient.

2. The speech recognition method as claimed in claim 1, wherein said recognition results are shown on a displaying device.

3. The speech recognition method as claimed in claim 2, wherein said displaying device is a touch screen.

4. The speech recognition method as claimed in claim 1, wherein said correct values in said recognition results are locked by said user with a locking device.

5. The speech recognition method as claimed in claim 4, wherein said locking device is one selected from a group consisting of a button, said touch screen and a remote controller.

6. The speech recognition method as claimed in claim 1, wherein said known values are stored in a storage device.

7. The speech recognition method as claimed in claim 6, wherein said storage device is a register.

8. The speech recognition method as claimed in claim 1, wherein said database is one selected from a group consisting of a memory, a flash disk, a hard disk and a remote server.

9. The speech recognition method as claimed in claim 1, further comprising a step of re-recognizing said speech from said user when a part of said correct values is known.

10. A speech recognition method, comprising steps of:
(a) displaying a plurality of fields on a displaying device, wherein each of said field corresponds to an attribute;
(b) inputting a speech by a user based on said attribute;
(c) recognizing said speech to generate a plurality of recognition results;
(d) displaying said recognition results in corresponding fields for said user to lock correct values in said recognition results with a locking device;
(e) determining whether said correct values are sufficient for searching a database;
(f) saving said correct values as know values to narrow the recognition range and repeating step (b) to step (e) when said correct values are insufficient for searching said database; and
(g) searching said database for a desired datum based on said correct values when said correct values are sufficient.

11. The speech recognition method as claimed in claim 10, further comprising a step of re-recognizing said speech from said user when a part of said correct values is known.

12. The speech recognition method as claimed in claim 10, further comprising a step of automatically searching for said desired datum without completely filling said fields.

13. A speech recognition system, comprising:
a speech input device for receiving a speech from a user;
a speech recognition device connected to said speech input device for recognizing said speech to generate a plurality of recognition results;
a displaying device connected to said speech recognition device for displaying said recognition results;
a locking device connected to said displaying device for said user to lock correct values in said recognition results;
a storage device for saving said correct values as known values; and
a database for storing a desired datum to be searched according to said correct values.

14. The speech recognition system as claimed in claim 13, wherein said displaying device is a touch screen.

15. The speech recognition system as claimed in claim 14, wherein said locking device is one selected from a group consisting of a button, said touch screen and a remote controller.

16. The speech recognition system as claimed in claim 13, wherein said storage device is a register.

17. The speech recognition system as claimed in claim 13, wherein said correct values are saved as said known values via said storage device when said correct values are insufficient.

18. The speech recognition system as claimed in claim 13, wherein said database is one selected from a group consisting of a memory, a flash disk, a hard disk and a remote server.

19. The speech recognition system as claimed in claim 13, wherein said desired datum is searched from said database based on said correct values when said correct values are sufficient for searching said database.

20. A speech recognition method, comprising steps of:
(a) receiving a speech from a user and recognizing said speech for generating a plurality of recognition results;
(b) displaying one of said recognition results for said user to confirm/correct said recognition result;
(c) repeating step (b) until all of said recognition results are confirmed/corrected by said user; and
(d) searching for a desired datum based on said confirmed/corrected recognition results.

21. The speech recognition method as claimed in claim 20, wherein said recognition results are shown one by one on a specific region of a displaying device.

22. The speech recognition method as claimed in claim 21, wherein said recognition results are shown as an ‘attribute-value’ format.

23. The speech recognition method as claimed in claim 22, wherein said attributes and said values are confirmed/corrected one by one by said user via a control device.

24. The speech recognition method as claimed in claim 23, wherein said control device is one selected from a group consisting of a keypad, a remote controller and a personal digital assistant.

25. The speech recognition method as claimed in claim 24, wherein said keypad comprises a recording/playing button, an accepting button, a rejecting button, an attribute-correcting button and a value-correcting button.

26. The speech recognition method as claimed in claim 23, further comprising a step of searching for said desired datum based on said confirmed/corrected attributes and said confirmed/corrected values after one of said attributes and said values is confirmed/corrected.

27. The speech recognition method as claimed in claim 21, further comprising a step of determining whether said attributes and said values which are not confirmed/corrected need to be confirmed/corrected continuously.

28. A speech recognition system, comprising:
an input device for receiving a speech from a user;
a speech recognition understanding device connected to said input device for generating a plurality of recognition results in response to said speech;
a confirmation/correction module connected to said speech recognition understanding device for confirming/correcting said recognition results;
a displaying device connected to said confirmation/correction module for displaying said recognition results one by one on a specific region thereof;
a control device connected to said confirmation/correction module for said user to confirm/correct said recognition results; and
a search module connected to said confirmation/correction module for searching for a desired datum based on said confirmed/corrected recognition results.

29. The speech recognition system as claimed in claim 28, further comprising a storage/receiving device for storing said datum.

30. The speech recognition system as claimed in claim 29, wherein said datum is one of a digital datum and a video program.

31. The speech recognition system as claimed in claim 28, wherein said input device is a microphone.

32. The speech recognition system as claimed in claim 28, wherein said speech recognition understanding device comprises a speech recognition device and a language understanding device.

33. The speech recognition system as claimed in claim 32, wherein said speech recognition device performs a speech recognition based on a lexicon.

34. The speech recognition system as claimed in claim 32, wherein said language understanding device performs a language understanding based on a grammar rule.

35. The speech recognition system as claimed in claim 28, wherein said recognition results are shown as an ‘attribute-value’ format.

36. The speech recognition system as claimed in claim 28, wherein said confirmation/correction module is an interactive meaning confirmation/correction software.

37. The speech recognition system as claimed in claim 28, wherein said control device is one selected from a group consisting of a keypad, a remote controller and a personal digital assistant.

38. The speech recognition system as claimed in claim 37, wherein said keypad comprises a recording/playing button, an accepting button, a rejecting button, an attribute-correcting button and a value-correcting button.

39. The speech recognition system as claimed in claim 28, wherein said search unit is a search software.

40. A speech recognition method, comprising steps of:
(a) receiving a speech from a user and recognizing said speech for generating a plurality of recognition results;
(b) displaying said recognition results for said user to confirm/correct said recognition results; and
(c) searching for a desired datum based on said confirmed/corrected recognition results.

41. The speech recognition method as claimed in claim 40, wherein said recognition results are shown simultaneously.

42. The speech recognition method as claimed in claim 40, wherein said recognition results are shown one by one.

43. The speech recognition method as claimed in claim 40, wherein said step (b) is performed by receiving a next speech from said user.

44. The speech recognition method as claimed in claim 40, wherein said step (b) is performed by means of a control device.
